(19) United States
(12) Patent Application Publication
(10) Pub. No.: US 2014/0143804 A1
(43) Pub. Date: May 22, 2014

(54) SYSTEM AND METHOD FOR PROVIDING ADVERTISEMENT SERVICE

(71) Applicant: INSTITUTE FOR INFORMATION INDUSTRY, Taipei (TW)

(72) Inventors: Bin-Yi CHENG, Taipei City (TW); Chi-Hung TSAI, Taipei City (TW)

(73) Assignee: INSTITUTE FOR INFORMATION INDUSTRY, Taipei (TW)

(21) Appl. No.: 13/713,837

(22) Filed: Dec. 13, 2012

(30) Foreign Application Priority Data
Nov. 16, 2012 (TW) 101142755

(51) Int. Cl. H04N 21/81

(52) U.S. Cl. CPC H04N 21/812
USPC 725/34

(57) ABSTRACT

A method for providing an advertisement service includes the steps of: receiving an identification code of a personal networked device via a network from a client end; obtaining a user preference datum corresponding to the identification code from a user preference database; searching an advertisement data platform according to the user preference datum to select one or more recommended advertisements; transmitting the recommended advertisements via the network to the client end; and displaying the recommended advertisements on a networked TV (television) or the personal networked device of the client end.

### CROSS REFERENCE TO RELATED APPLICATIONS

This Application claims priority of Taiwan Patent Application No. 101142755 filed on Nov. 16, 2012, the entirety of which is incorporated by reference herein.

### BACKGROUND OF THE INVENTION

1. Field of the Invention

The disclosure generally relates to an advertisement service system, and more particularly, relates to an advertisement service system for selecting display contents consistent with user preferences.

2. Description of the Related Art

For traditional TV (television) advertising, most advertisements are ineffective because viewers may not pay any attention to them. Nowadays, personal networked advertisement systems generally provide personalized advertisements via a GPS (Global Positioning System) and an on-line network of a networked device (including search records and advertisement click records). However, the advertisement information is messy and the viewers may not be interested. To solve the foregoing problem, it is a critical challenge for advertisers to design suitable personalized/grouped network advertisements for users, enhancing the effectiveness of advertisements at a reasonable cost.

### BRIEF SUMMARY OF THE INVENTION

In one exemplary embodiment, the subject application is directed to an advertisement service system, comprising: a client end, comprising: a networked TV (television); a personal networked device, providing an identification code; and a client transceiver unit, transmitting the identification code; a network; and a server end, communicating with the client end via the network, and comprising: a server transceiver unit, receiving the identification code; a TV/network advertisement and program database; an advertisement data platform; a user preference database, providing a user preference datum corresponding to the identification code; and a user behavior analysis unit, searching the advertisement data platform according to the user preference datum to select one or more recommended advertisements, wherein the server transceiver unit further transmits the recommended advertisements via the network to the client transceiver unit, and the networked TV or the personal networked device is configured to display the recommended advertisements.

In another exemplary embodiment, the subject application is directed to a method for providing an advertisement service, comprising the steps of: receiving an identification code of a personal networked device via a network from a client end; obtaining a user preference datum corresponding to the identification code from a user preference database; searching an advertisement data platform according to the user preference datum to select one or more recommended advertisements; transmitting the recommended advertisements via the network to the client end; and displaying the recommended advertisements on a networked TV (television) or the personal networked device of the client end.

In one exemplary embodiment, the subject application is directed to a non-transitory computer-readable medium storing a computer program product operable to perform operations comprising: receiving an identification code of a personal networked device via a network from a client end; obtaining a user preference datum corresponding to the identification code from a user preference database; searching an advertisement data platform according to the user preference datum to select one or more recommended advertisements; transmitting the recommended advertisements via the network to the client end; and displaying the recommended advertisements on a networked TV (television) or the personal networked device of the client end.

### BRIEF DESCRIPTION OF DRAWINGS

The invention can be more fully understood by reading the subsequent detailed description and examples with references made to the accompanying drawings, wherein:

FIG. 1 is a diagram for illustrating an advertisement service system according to an embodiment of the invention;

FIG. 2 is a diagram for illustrating an advertisement service system according to a preferred embodiment of the invention; and

FIG. 3 is a flowchart for illustrating a method for providing an advertisement service according to an embodiment of the invention.

### DETAILED DESCRIPTION OF THE INVENTION

In order to illustrate the purposes, features and advantages of the invention, the embodiments and figures thereof in the invention are shown in detail as follows.

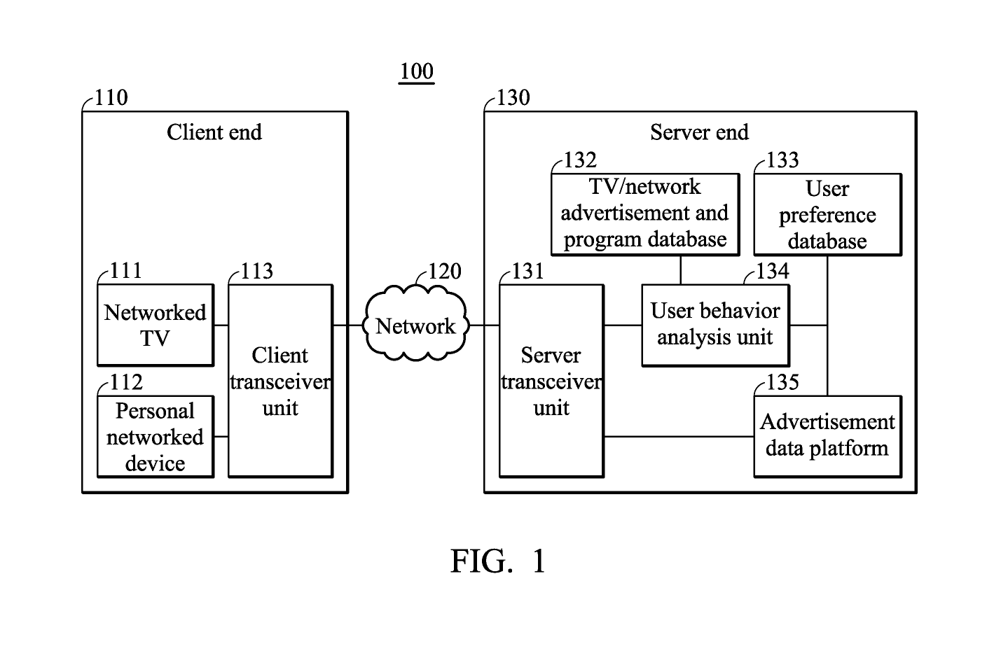

FIG. 1 is a diagram for illustrating an advertisement service system 100 according to an embodiment of the invention. As shown in FIG. 1, the advertisement service system 100 comprises a client end 110, a network 120, and a server end 130. The network 120 may be a wired network or a wireless network, for example, an Ethernet, an optical fiber network, a Wi-Fi network, or a mobile wireless network. The server end 130 communicates with the client end 110 via the network 120. The client end 110 at least comprises a networked TV (television) 111, at least one personal networked device 112, and a client transceiver unit 113. The server end 130 comprises a server transceiver unit 131, a TV/network advertisement and program database 132, a user preference database 133, a user behavior analysis unit 134, and an advertisement data platform 135. The TV/network advertisement and program database 132 stores some predetermined TV/network advertisements and programs, and schedules thereof. Note that “unit”, “platform”, and “database” of the disclosure may be implemented with software (e.g., computer codes) or hardware (e.g., integrated circuits, ICs).

The advertisement service system 100 may be operated as follows. The personal networked device 112 provides an identification code. In some embodiments, the identification code is a device identification code or an IP (Internet Protocol) address. The identification code is used to distinguish the personal networked device 112. The client transceiver unit 113 transmits the identification code via the network 120 to the server transceiver unit 131. The user behavior analysis unit 134 looks up the user preference database 133 according to the identification code, and the user preference database 133 provides a user preference datum corresponding to the identification code. In some embodiments, the user preference database 133 may store a plurality of historical user preference data, for example, a first identification code corresponding to the preference for foods, a second identification code corresponding to the preference for travel, and a third identification code corresponding to the preference for mobile technology, etc. Next, the user behavior analysis unit 134 searches the advertisement data platform 135 according to the user preference datum to select one or more recommended advertisements. In some embodiments, the advertisement data platform 135 may store a variety of advertisements, and the selected recommended advertisements are consistent with the user preference datum. Then, the server transceiver unit 131 further transmits the recommended advertisements via the network 120 to the client transceiver unit 113. The networked TV 111 or the personal networked device 112 is configured to display the recommended advertisements. In some embodiments, the recommended advertisements may be TV advertisements, or application program advertisements of mobile devices.

In the invention, the advertisement service system 100 selects appropriate display contents according to the user preference datum. For example, a restaurant advertisement is transmitted to a user having the preference for foods, a traveling group advertisement is transmitted to a user having the preference for travel, and a tablet computer advertisement is transmitted to a user having the preference for mobile technology. Under this customized design, the advertisement effectiveness is enhanced, thus, saving ineffective advertising costs. In a preferred embodiment, the personal networked device 112 is a mobile device, for example, a smart phone, a tablet computer, or a notebook computer. Since the server end 130 selects the recommended advertisements according to an identification code of a mobile device, the invention is not limited by the location where the user lives, and may be applied to different locations.

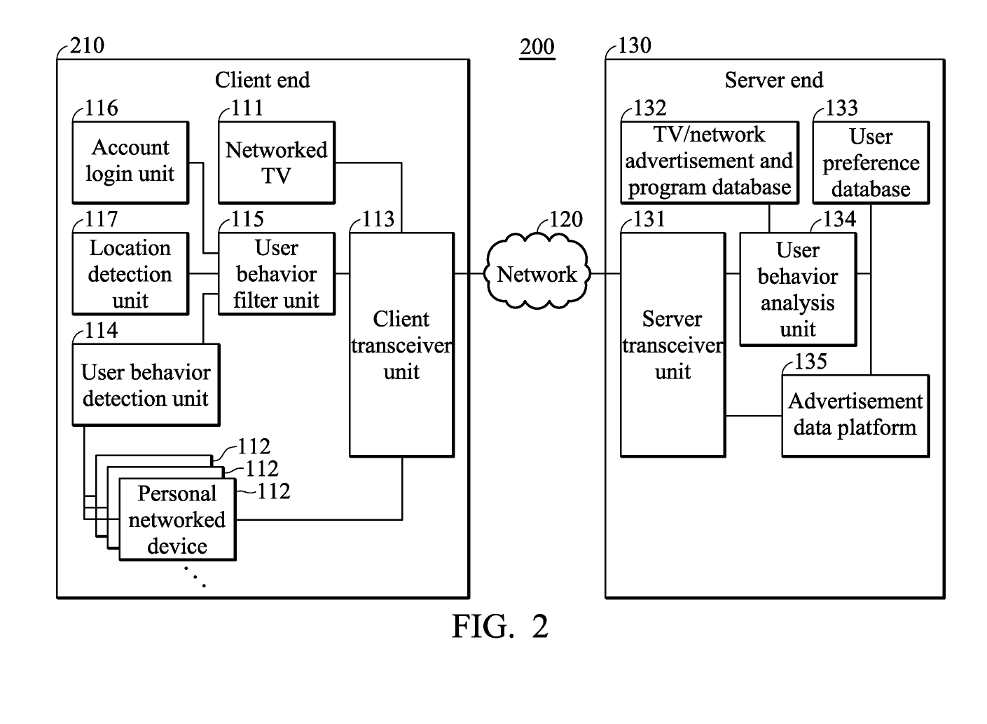

FIG. 2 is a diagram for illustrating an advertisement service system 200 according to a preferred embodiment of the invention. As shown in FIG. 2, a client end 210 of the advertisement service system 200 further comprises a user behavior detection unit 114, a user behavior filter unit 115, an account login unit 116, and a location detection unit 117.

The user behavior detection unit 114 is configured to detect user behavior information related to the personal networked device 112. The user behavior information may comprise historical watching behavior information, on-line network behavior information, and social network behavior information. In some embodiments, the user behavior detection unit 114 is a set-top box or a remote controller, and is arranged for detecting channel-selection records of a user. In some embodiments, the user behavior detection unit 114 is an application program built in a mobile device or a smart TV, and is arranged for detecting browsing records and posting records of a user on a social website (e.g., Facebook or Google+). The client transceiver unit 113 may further transmit the user behavior information via the network 120 to the server transceiver unit 131. The user behavior analysis unit 134 may update the user preference database 133 according to the user behavior information. For example, if the personal networked device 112 providing a first identification code brows some travel websites, the user preference database 133 can further store the first identification code corresponding to the preference for travel. The user behavior analysis unit 134 may further search the advertisement data platform 135 according to the user behavior information to select the recommended advertisements.

The account login unit 116 is configured to receive social relationship information and personal information. In some embodiments, the account login unit 116 is an application program built in a mobile device or a smart TV, and the application program is used for receiving an account and a password of a social website (e.g., Facebook or Google+) and for accordingly receiving the social relationship information and the personal information. The client transceiver unit 113 may further transmit the social relationship information and the personal information via the network 120 to the server transceiver unit 131. The user behavior analysis unit 134 may update the user preference database 133 according to the social relationship information and the personal information. For example, if the personal networked device 112 providing a first identification code logs into travel groups of a social website, the user preference database 133 can further store the first identification code corresponding to the preference for travel. The user behavior analysis unit 134 may further search the advertisement data platform 135 according to the social relationship information and the personal information to select the recommended advertisements.

In some embodiments, the client end 210 may selectively include the location detection unit 117. The location detection unit 117 is configured to detect location information of the personal networked device 112. In some embodiments, the location detection unit 117 is a GPS (Global Positioning System) module of the personal networked device 112. The client transceiver unit 113 may further transmit the location information via the network 120 to the server transceiver unit 131. The user behavior analysis unit 134 may update the user preference database 133 according to the location information. The user behavior analysis unit 134 may further search the advertisement data platform 135 according to the location information to select the recommended advertisements. For example, if the personal networked device 112 providing a first identification is located in Taipei, the user behavior analysis unit 134 can select some Taipei restaurant advertisements as the recommended advertisements.

In some embodiments, the networked TV 111 is a smart TV, and the personal networked device 112 is integrated as an inner component of the smart TV 111.

In some embodiments, the client end 210 may selectively include the user behavior filter unit 115. The user behavior filter unit 115 is configured to analyze and filter the user behavior information and other information from the personal networked device 112, the user behavior detection unit 114, the account login unit 116, and the location detection unit 117, so as to remove irrelevant information. Accordingly, the user behavior filter unit 115 can help to reduce the computational burden of the user behavior analysis unit 134 of the server end 130.

In some embodiments, the client end 210 further comprises a plurality of personal networked devices 112, and the personal networked devices 112 provide a plurality of identification codes. After the identification codes are transmitted to the server end 130, the user behavior analysis unit 134 looks up the user preference database 133 according to the identification codes, and the user preference database 133 provides a grouped user preference datum corresponding to the identification codes. In some embodiments, the grouped user preference datum is an intersection of a plurality of user preference data corresponding to the identification codes. In some embodiments, the grouped user preference datum is a union of the plurality of user preference data corresponding to the identification codes. The user behavior analysis unit 134 may search the advertisement data platform 135 according to the grouped user preference datum to select the recommended advertisements. In other words, the invention is not only applied to personalized advertisement services but also generalized grouped advertisement services. The advertisement service system 200 may display grouped recommended advertisements for a group of users having specific preferences in front of the networked TV 111. Other features of the grouped advertisement service are similar to those in the embodiments of FIG. 1 and FIG. 2, and will not be illustrate again herein.

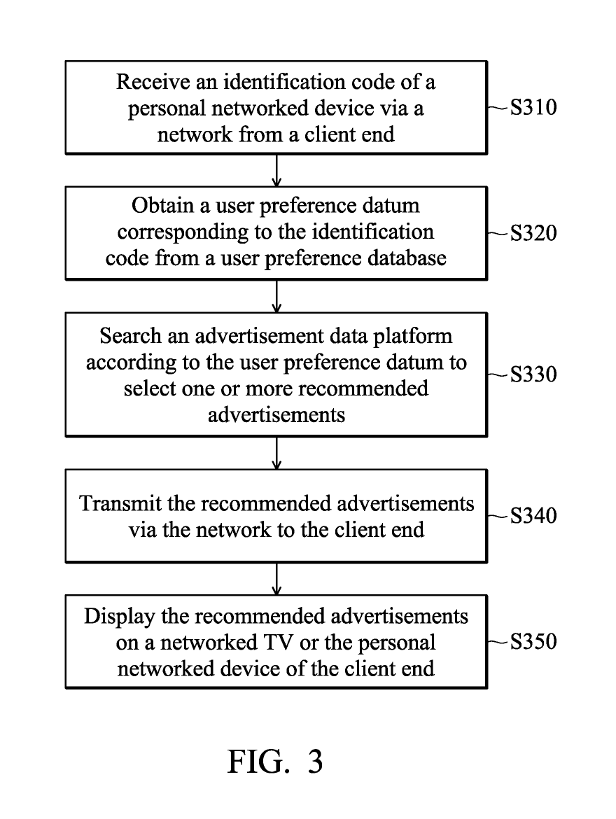

FIG. 3 is a flowchart for illustrating a method for providing an advertisement service according to an embodiment of the invention. To begin, in step S310, an identification code of a personal networked device is received via a network from a client end. In step S320, a user preference datum corresponding to the identification code is obtained from a user preference database. In step S330, an advertisement data platform is searched according to the user preference datum to select one or more recommended advertisements. In step S340, the recommended advertisements are transmitted via the network to the client end. Finally, in step S350, the recommended advertisements are displayed on a networked TV (television) or the personal networked device of the client end. Note that every detailed feature in the embodiments of FIG. 1 and FIG. 2 may be applied to the method for providing the advertisement service in FIG. 3.

The method of the invention, or certain aspects or portions thereof, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

It will be apparent to those skilled in the art that various modifications and variations can be made in the invention. It is intended that the standard and examples be considered as exemplary only, with a true scope of the disclosed embodiments being indicated by the following claims and their equivalents.

1. An advertisement service system, comprising:
a client end, comprising:
a networked TV (television);
a personal networked device, providing an identification code; and
a client transceiver unit, transmitting the identification code;
a network; and
a server end, communicating with the client end via the network, and comprising:
a server transceiver unit, receiving the identification code;
a TV/network advertisement and program database;
an advertisement data platform;
a user preference database, providing a user preference datum corresponding to the identification code; and
a user behavior analysis unit, searching the advertisement data platform according to the user preference datum to select one or more recommended advertisements,
wherein the server transceiver unit further transmits the recommended advertisements via the network to the client transceiver unit, and the networked TV or the personal networked device is configured to display the recommended advertisements,.
wherein the client end further comprises a plurality of personal networked devices, the personal networked devices provide a plurality of identification codes, the user preference database further provides a grouped user preference datum corresponding to the identification codes, and the user behavior analysis unit further searches the advertisement data platform according to the grouped user preference datum to select the recommended advertisements, and
wherein the grouped user preference datum is an intersection of a plurality of user preference data corresponding to the identification codes.

2. The advertisement service system as claimed in claim 1, wherein the client end further comprises a user behavior detection unit for detecting user behavior information.

3. The advertisement service system as claimed in claim 2, wherein the user behavior information comprises historical watching behavior information, on-line network behavior information, and social network behavior information.

4. The advertisement service system as claimed in claim 2, wherein the client transceiver unit further transmits the user behavior information via the network to the server transceiver unit, and the user behavior analysis unit updates the user preference database according to the user behavior information.

5. The advertisement service system as claimed in claim 2, wherein the client end further comprises a user behavior filter unit for filtering the user behavior information.

6. The advertisement service system as claimed in claim 1, wherein the client end further comprises an account login unit for receiving social relationship information and personal information.

7. The advertisement service system as claimed in claim 6, wherein the client transceiver unit further transmits the social relationship information and the personal information via the network to the server transceiver unit, and the user behavior analysis unit further searches the advertisement data platform according to the social relationship information and the personal information to select the recommended advertisements.

8. The advertisement service system as claimed in claim 1, wherein the client end further comprises a location detection unit for detecting location information of the personal networked device.

9. The advertisement service system as claimed in claim 8, wherein the client transceiver unit further transmits the location information via the network to the server transceiver unit, and the user behavior analysis unit further searches the advertisement data platform according to the location information to select the recommended advertisements.

10. The advertisement service system as claimed in claim 1, wherein the personal networked device is a mobile device.

11. The advertisement service system as claimed in claim 10, wherein the mobile device is a smart phone, a tablet computer, or a notebook computer.

12. The advertisement service system as claimed in claim 1, wherein the networked TV is a smart TV, and the personal networked device is integrated as an inner component of the smart TV.

13-14. (canceled)

15. A method for providing an advertisement service, comprising the steps of:
receiving an identification code of a personal networked device via a network from a client end;
obtaining a user preference datum corresponding to the identification code from a user preference database;
searching an advertisement data platform according to the user preference datum to select one or more recommended advertisements;
transmitting the recommended advertisements via the network to the client end; and
displaying the recommended advertisements on a networked TV (television) or the personal networked device of the client end;
wherein the client end further comprises a plurality of personal networked devices, and the method further comprises the steps of:
receiving a plurality of identification codes of the personal networked devices via the network from the client end;
obtaining a grouped user preference datum corresponding to the identification codes from the user preference database; and
searching the advertisement data platform according to the grouped user preference datum to select the recommended advertisements,
wherein the grouped user preference datum is an intersection of a plurality of user preference data corresponding to the identification codes.

16. The method as claimed in claim 15, further comprising:
detecting user behavior information of the client end.

17. The method as claimed in claim 16, wherein the user behavior information comprises historical watching behavior information, on-line network behavior information, and social network behavior information.

18. The method as claimed in claim 16, further comprising:
receiving the user behavior information via the network from the client end; and
updating the user preference database according to the user behavior information.

19. The method as claimed in claim 16, further comprising:
filtering the user behavior information.

20. The method as claimed in claim 15, further comprising:
receiving social relationship information and personal information of the client end.

21. The method as claimed in claim 20, further comprising:
receiving the social relationship information and the personal information via the network from the client end; and
searching the advertisement data platform according to the social relationship information and the personal information to select the recommended advertisements.

22. The method as claimed in claim 15, further comprising:
detecting location information of the personal networked device of the client end.

23. The method as claimed in claim 22, further comprising:
receiving the location information via the network from the client end; and
searching the advertisement data platform according to the location information to select the recommended advertisements.

24. The method as claimed in claim 15, wherein the personal networked device is a mobile device.

25. The method as claimed in claim 24, wherein the mobile device is a smart phone, a tablet computer, or a notebook computer.

26. The method as claimed in claim 15, wherein the networked TV is a smart TV, and the personal networked device is integrated as an inner component of the smart TV.

27-28. (canceled)

29. A non-transitory computer-readable medium storing a computer program product operable to perform operations comprising:
receiving an identification code of a personal networked device via a network from a client end;
obtaining a user preference datum corresponding to the identification code from a user preference database;
searching an advertisement data platform according to the user preference datum to select one or more recommended advertisements;
transmitting the recommended advertisements via the network to the client end; and
displaying the recommended advertisements on a networked TV (television) or the personal networked device of the client end;
wherein the client end further comprises a plurality of personal networked devices, and the operations further comprises:
receiving a plurality of identification codes of the personal networked devices via the network from the client end;
obtaining a grouped user preference datum corresponding to the identification codes from the user preference database; and
searching the advertisement data platform according to the grouped user preference datum to select the recommended advertisements,
wherein the grouped user preference datum is an intersection of a plurality of user preference data corresponding to the identification codes.
